(19) United States
(12) Patent Application Publication
(10) Pub. No.: US 2026/0085439 A1
(43) Pub. Date: Mar. 26, 2026

(54) PLATED MEMBER AND MANUFACTURING METHOD THEREOF

(71) Applicant: Hitachi Astemo, Ltd., Ibaraki (JP)

(72) Inventors: Yasuhisa OMATA, Hitachinaka-shi (JP); Akihito HOSHINO, Hitachinaka-shi (JP); Hiroshi NAKANO, Hitachinaka-shi (JP)

(21) Appl. No.: 19/108,760

(22) PCT Filed: Sep. 5, 2023
(86) PCT No.: PCT/JP2023/032351

§ 371 Date: Mar. 5, 2025

(30) Foreign Application Priority Data
Sep. 7, 2022 (JP) 2022-142217

(51) Int. Cl. C25D 3/06; B32B 15/01

(52) U.S. Cl. CPC C25D 3/06; B32B 15/013; B32B 2250/02; B32B 2311/30

(57) ABSTRACT

Provided is a plated member having, on an outer surface, a plated film mainly composed of chromium formed using a trivalent chromium bath containing at least chromium, carbon, and oxygen, in which the plated film contains 60 at % or more of chromium and 1 at % to 30 at % of carbon and has an indentation hardness of 11.1 GPa or more on the outer surface, and a degree of crystallinity calculated from a peak integrated intensity ratio of a measured value of X-ray diffraction measurement and the following expression (1) is 5% or more.

### TECHNICAL FIELD

The present invention relates to a plated member and a manufacturing method thereof.

Priority is claimed on Japanese Patent Application No. 2022-142217, filed Sep. 7, 2022, the content of which is incorporated herein by reference.

### BACKGROUND ART

A technology in which a chromium-plating layer of trivalent chromium, which poses no problems in terms of toxicity and pollution compared to hexavalent chromium, is used for a platemaking roll is described in Patent Document 1 below.

### CITATION LIST

### Patent Document

Patent Document 1: Japanese Unexamined Patent Application, First Publication No. 2008-143169

### SUMMARY OF INVENTION

### Technical Problem

In a chromium-plated film formed on a rod that is in sliding contact with a sliding component, a chromium-plated film using a trivalent chromium bath is considered a promising alternative to a hexavalent chromium-plated film.

Incidentally, through research conducted by inventors of the present invention, it was found that, when a rod on which a chromium-plated film using a conventional trivalent chromium bath had been formed was polished, brittle fracture (tearing fracture) of the plated film was generated.

A problem to be solved by the present invention is to provide a plated member such as a rod having a chromium-plated film using a trivalent chromium bath and less susceptible to occurrence of tearing fractures during polishing, and a manufacturing method thereof.

### Solution to Problem

A plated member according to one aspect of the present invention includes, on an outer surface, a plated film mainly composed of chromium formed using a trivalent chromium bath containing at least chromium, carbon, and oxygen, in which the plated film contains 60 at % or more of chromium and 1 at % to 30 at % of carbon and has an indentation hardness of 11.1 GPa or more on the outer surface, and a degree of crystallinity calculated from a peak integrated intensity ratio of a measured value of X-ray diffraction measurement and the following expression (1) is 5% or more.

$$Degree of crystallinity ( peak integrated intensity ratio ) = \{ ( Crystalline ) / ( Crystalline + Amorphous ) \} \times 100 \% \qquad Expression ( 1 )$$

Here, the indentation hardness indicates a value obtained by instrumented indentation hardness measurement using a nanoindentation method (ISO 14577), and the integrated intensity ratio in expression (1) indicates a value determined in an X-ray diffraction (XRD) analysis under conditions of 2θ: 30° to 60°, a half width of crystalline: <3, and a half width of amorphous: ≥3.

Also, a manufacturing method of a plated member according to one aspect of the present invention is a manufacturing method of a plated member which is a plated member having, on an outer surface, a plated film which is mainly composed of chromium formed using a trivalent chromium bath containing at least chromium, carbon, and oxygen, contains 60 at % or more of chromium and 1 at % to 30 at % of carbon and has an indentation hardness of 11.1 GPa or more on the outer surface, and has a degree of crystallinity calculated from a peak integrated intensity ratio of a measured value of X-ray diffraction measurement and the above expression (1) being 5% or more, and the manufacturing method of a plated member includes a plating process which forms a plated film made of a hard layer mainly composed of chromium on a surface of the plated member, and has a first step of forming an amorphous plated film, and a second step of heating and crystallizing the amorphous plated film formed in the first step.

### Advantageous Effects of Invention

According to the above-described aspect of the present invention, it is possible to provide a plated member having a chromium-plated film which is a plated film mainly composed of chromium formed using a trivalent chromium bath that poses no environmental problems compared to hexavalent chromium and is less susceptible to occurrence of tearing fractures during polishing. Also, it is possible to provide a manufacturing method for manufacturing the plated member.

### BRIEF DESCRIPTION OF DRAWINGS

FIG. 1 A view showing an overall configuration of a shock absorber including a piston rod as a first embodiment of a plated member according to the present invention, and is a cross-sectional view seen in a cross section including a center line CL.

FIG. 2 A side view showing an approximate shape of the piston rod.

FIG. 3 A view showing an upper structure of the shock absorber, and is an enlarged partial cross-sectional view of a part A in FIG. 1.

FIG. 4 A view showing a structure of a distal end part of the piston rod, and is an enlarged partial cross-sectional view of a part B in FIG. 1.

FIG. 5 A flowchart showing an example of a manufacturing process of the piston rod.

FIG. 6 A perspective view of a main part showing an example of a polishing device used for outer diameter polishing of the piston rod.

FIG. 7 A graph showing a relationship between a film formation rate and a degree of crystallinity of plated films formed in examples.

FIG. 8 A graph showing a relationship between a film formation rate and an impurity element concentration of the plated films formed in the examples.

FIG. 9 A table showing physical property values of the plated films formed in the examples.

FIG. 10 A table showing a relationship between a physical property value and a heat treatment temperature of plated films formed in examples.

FIG. 11 Images showing abrasive marks in brittle mode formed on a plated film of a comparative example sample, in which (A) is an enlarged image at a magnification of 500 times, and (B) is an enlarged image at a magnification of 5000 times.

FIG. 12 Images showing abrasive marks in ductile mode formed on a plated film of an example sample, in which (A) is an enlarged image at a magnification of 500 times, and (B) is an enlarged image at a magnification of 5000 times.

FIG. 13 (A) is a diagram showing X-ray diffraction analysis results of a comparative example sample, and (B) is a surface image showing abrasive marks of the same sample.

FIG. 14 (A) is a diagram showing X-ray diffraction analysis results of an example sample that was heat-treated at 250° C., and (B) is a surface image showing abrasive marks of the same sample.

FIG. 15 (A) is a diagram showing X-ray diffraction analysis results of an example sample that was heat-treated at 300° C., and (B) is a surface image showing abrasive marks of the same sample.

FIG. 16 A graph showing a relationship between a heat treatment temperature (baking temperature) and a maximum width of abrasive marks in the example samples and comparative example samples.

FIG. 17 A graph showing a relationship between a heat treatment temperature (baking temperature) and the number of abrasive marks having a width of 8 μm or more in the example samples and comparative example samples.

FIG. 18 A graph showing a relationship between a heat treatment temperature (baking temperature) and a plating hardness in the example samples and comparative example samples.

FIG. 19 A graph showing a relationship between a heat treatment temperature (baking temperature) and a degree of crystallinity in the example samples and comparative example samples.

FIG. 20 A graph showing a relationship between a plating hardness and the number of abrasive marks having a width of 8 μm or more in the example samples and comparative example samples.

FIG. 21 A graph showing a relationship between a degree of crystallinity and the number of abrasive marks having a width of 8 μm or more in the example samples and comparative example samples.

FIG. 22 is a graph showing a relationship between a plating hardness and a degree of crystallinity in the example samples and comparative example samples.

### DESCRIPTION OF EMBODIMENTS

Hereinafter, a shock absorber (cylinder device) having a piston rod as one embodiment of a plated member according to the present invention will be described.

Further, the embodiment described below is specifically described to allow a better understanding of the spirit of the invention, and is not intended to limit the present invention unless otherwise specified. Also, scales of the drawings used in the description of the embodiment below have been appropriately changed to make each portion easier to see.

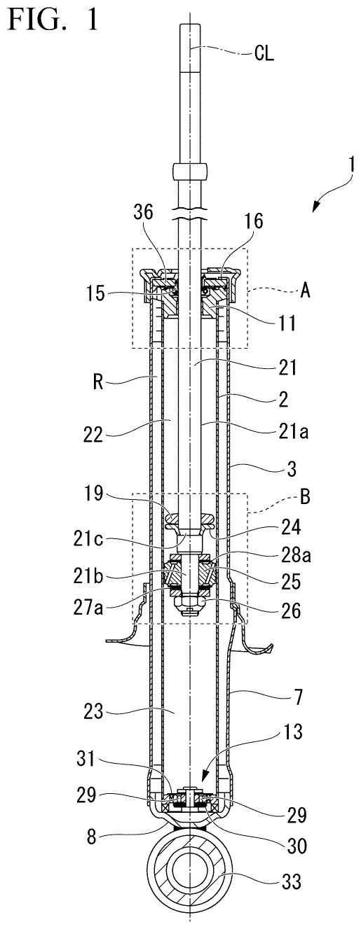

FIG. 1 is a partial cross-sectional view showing an overall structure of a shock absorber (cylinder device) 1 including a piston rod 21 as an example of the plated member according to the present invention.

Although a plated film to be described later is formed on an outer circumferential surface of the piston rod 21, before describing the plated film, an overall configuration of the shock absorber 1 will be described.

### “Cylinder Device”

The cylinder device 1 shown in FIG. 1 is a shock absorber used in a suspension device for an automobile or a railway vehicle, and specifically, is used for a strut-type suspension device for an automobile. The cylinder device 1 includes a cylindrical inner cylinder (cylinder) 2 in which a working fluid is sealed, and a bottomed cylindrical outer cylinder 3 having a larger diameter than the inner cylinder 2, provided on an outer circumferential side of the inner cylinder 2, forming a reservoir chamber R between itself and the inner cylinder 2 in which a working liquid and a working gas are sealed. The cylinder device 1 is a dual-tube type shock absorber in which the inner cylinder 2 is provided inside the outer cylinder 3. In FIG. 1, CL indicates a center line of the inner cylinder 2 and the outer cylinder 3.

The outer cylinder 3 includes a cylindrical side wall portion 7 and a bottom portion 8 that closes one end side of the side wall portion 7 in an axial direction. The inner cylinder 2 has a cylindrical shape. The inner cylinder 2 is engaged with the bottom portion 8 of the outer cylinder 3 via an annular base valve 13 attached to one end part in an axial direction of the inner cylinder 2. The inner cylinder 2 is engaged with the other end side of the side wall portion 7 in the axial direction via an annular rod guide 11 attached to the other end part in the axial direction of the inner cylinder 2.

The base valve 13 is disposed coaxially with the outer cylinder 3, and the rod guide 11 is fitted into the inner cylinder 2 and the outer cylinder 3 to support the other end part of the inner cylinder 2 coaxially with the outer cylinder 3.

An oil seal 15 is disposed on a side of the rod guide 11 opposite to the bottom portion 8 side. A locking portion 16 bent inward is formed on the other end part side of the side wall portion 7 in the axial direction, and the oil seal 15 is supported by the locking portion 16.

A piston 25 is slidably fitted in the inner cylinder 2. The piston 25 divides the inside of the inner cylinder 2 into a first chamber 22 and a second chamber 23. The first chamber 22 is formed between the piston 25 and the rod guide 11, and the second chamber 23 is formed between the piston 25 and the base valve 13. The second chamber 23 is divided from the reservoir chamber R by the base valve 13 provided on one end side of the inner cylinder 2.

The metal piston rod 21 is connected to the piston 25 by a nut 26. The piston rod 21 has a cylindrical large diameter portion 21a and passes through the rod guide 11 and the oil seal 15 to protrude to the outside from one end side of the inner cylinder 2 and the outer cylinder 3. The large diameter portion 21a of the piston rod 21 is slidably inserted into the inside of the rod guide 11 and the inside of the oil seal 15. Therefore, the oil seal 15 serves as a sliding component for the piston rod 21.

A small diameter portion 21b is formed on a distal end side of the piston rod 21, the piston 25 is inserted onto the small diameter portion 21b, the nut 26 is screwed onto a threaded portion at a distal end of the small diameter portion, and thereby the piston 25 is attached to the piston rod 21.

An annular groove 21c is formed in the large diameter portion 21a of the piston rod 21 at a position close to the small diameter portion 21b, and a ring-shaped internal stopper 24 is attached to engage with the annular groove 21c. A ring-shaped rebound rubber 19 is disposed on the internal stopper 24.

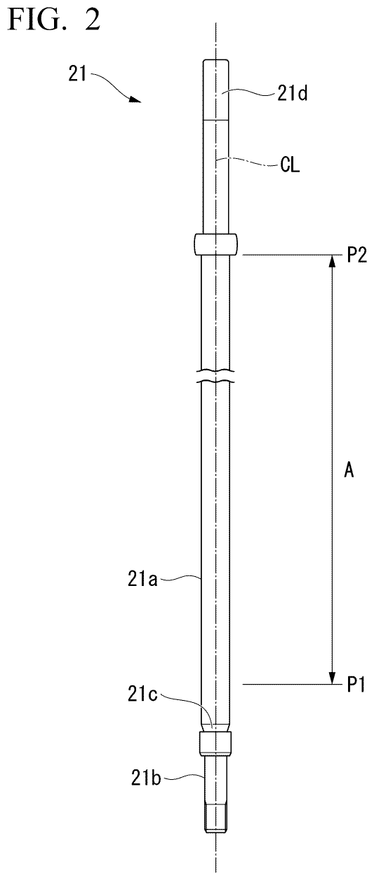

As shown in FIG. 2, in the large diameter portion 21a of the piston rod 21, a portion between a position P1 spaced apart from the annular groove 21c and a connection portion P2 with a bolt portion 21d serving as an attachment portion to a vehicle body is defined as a sliding range A.

A plated film mainly composed of chromium formed using a trivalent chromium bath to be described in detail later is formed on an outer circumferential surface of the piston rod 21 including the sliding range A.

The piston rod 21 moves together with the piston 25 in the axial direction. The oil seal 15 through which the large diameter portion 21a of the piston rod 21 passes seals a space between the inner cylinder 2 and the outer cylinder 3, and the piston rod 21, and prevents the working fluid in the inner cylinder 2 and the working gas and working fluid in the reservoir chamber R from leaking to the outside.

As shown in FIG. 4, passages 27 and 28 penetrating in the axial direction is formed in the piston 25. As shown in FIG. 1, the passages 27 and 28 allow the first chamber 22 and the second chamber 23 to communicate with each other. An annular disc valve 28a capable of closing the passage 28 by coming into contact with an upper surface of the piston 25 is formed in the piston 25. An annular disc valve 27a capable of closing the passage 27 by coming into contact with a lower surface of the piston 25 is formed in the piston 25.

When the piston rod 21 moves to a compression side (downward in FIG. 1) that increases an amount of entry into the inner cylinder 2 and the outer cylinder 3, the piston 25 moves in a direction in which the second chamber 23 is reduced. When a pressure in the second chamber 23 becomes higher than a pressure in the first chamber 22 by a predetermined value or more, the disc valve 28a opens the passage 28, thereby generating a damping force at that time.

When an upper end side of the piston rod 21 moves to an extension side (upward in FIG. 1) that increases an amount of protrusion from the inner cylinder 2 and the outer cylinder 3, the piston 25 moves in a direction in which the first chamber 22 is reduced. As a result, when a pressure in the first chamber 22 becomes higher than a pressure in the second chamber 23 by a predetermined value or more, the disc valve 27a opens the passage 27, thereby generating a damping force at that time.

As shown in FIG. 1, passages 29 and 29 penetrating the base valve 13 in the axial direction is formed in the base valve 13. The passages 29 allow the second chamber 23 and the reservoir chamber R to communicate with each other. An annular disc valve 30 capable of closing one of the passages 29 by coming into contact with a bottom surface side of the base valve 13 is disposed on the bottom surface side of the base valve 13. An annular disc valve 31 capable of closing the other passage 29 by coming into contact with an upper surface side of the base valve 13 is disposed on the upper surface side of the base valve 13.

The disc valve 30 is a check valve that allows a flow of the working fluid from the second chamber 23 to the reservoir chamber R side through the one passage 29, while restricting a flow of the working fluid through the passage 29 in a direction opposite thereto. The disc valve 30 serves as a valve that opens the passage 29 when the piston rod 21 moves to the compression side and a pressure in the second chamber 23 becomes higher than a pressure in the reservoir chamber R by a predetermined value or more.

The disc valve 31 is a check valve that allows a flow of the working fluid from the reservoir chamber R to the second chamber 23 side through the other passage 29, while restricting a flow of the working fluid through the passage 29 in direction opposite thereto. The disc valve 31 serves as a valve that opens the passage 29 when the piston rod 21 moves to the extension side and a pressure in the second chamber 23 becomes lower than a pressure in the reservoir chamber R by a predetermined value or more.

As shown in FIG. 1, a mounting eye 33 is attached to an outer side of the bottom portion 8. The cylinder device 1 is used by attaching an outer portion of the piston rod 21 and the mounting eye 33 between relative moving members that are objects to be attached.

The cylinder device 1 is used, for example, by connecting the outer end of the piston rod 21 to the vehicle body side and connecting the mounting eye 33 to a wheel side of the vehicle.

In the cylinder device 1, the piston rod 21 and the piston 25 slide integrally in the inner cylinder 2 to change volumes of the first chamber 22 and the second chamber 23. At that time, a damping force can be generated by a flow resistance of the liquid acting on the piston 25 and the base valve 13.

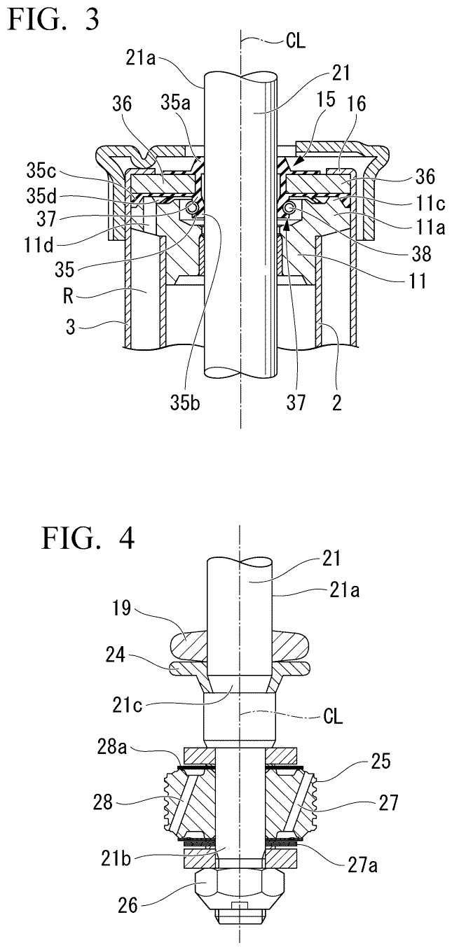

As shown in FIG. 3, the rod guide 11 has a substantially stepped annular shape with a large diameter portion 11a formed on one axial side and a small diameter portion formed on the other axial side. The large diameter portion 11a is fitted into an inner circumferential surface of the outer cylinder 3, and the small diameter portion is fitted into an inner circumferential surface of the inner cylinder 2.

An annular protruding portion 11c protruding in the axial direction is formed at an end part of the large diameter portion 11a of the rod guide 11, and a communication hole 11d that penetrates the rod guide 11 in the axial direction corresponding to a portion of the annular protruding portion 11c is formed. A side of the communication hole 11d opposite to the annular protruding portion side in the axial direction of the rod guide 11 opens to the reservoir chamber R.

The oil seal 15 includes a seal member main body 37 which is an integrally molded product in which an annular member 36 made of a metal is fitted into a seal material 35 made of synthetic rubber, and an annular spring 38 made of a metal. The annular member 36 maintains a shape of the seal material 35 and imparts strength to the seal member main body 37 for fixing it to a target portion. The seal member main body 37 is attached to an end part side of the outer cylinder 3 by sandwiching the annular member 36 between the locking portion 16 and the annular protruding portion 11c.

The seal material 35 includes a dust lip portion 35a, an oil lip portion 35b, a seal ring portion 35c, and a check lip portion 35d, and surrounds a circumference of the piston rod 21 to provide a seal function.

The cylinder device 1 during vehicle travel is configured such that the piston rod 21 or the outer cylinder 3 is repeatedly subjected to impact forces in the axial direction from the outside. Each time an impact force is received, the piston rod 21 moves to the compression side or the extension side, and a damping force acts at that time. In this way, the cylinder device 1 functions as a shock absorber used in a strut-type suspension of an automobile.

Also, a plated film made of chromium formed using a trivalent chromium bath, which will be described below, is provided on the outer circumferential surface of the piston rod 21. This plated film is a plated film that is less susceptible to brittle fracture (tearing failure) when the outer circumferential surface of the piston rod 21 is subjected to outer diameter polishing to achieve a desired surface roughness during manufacture. If the piston rod 21 has an outer circumferential surface that is finished to a polished surface with the desired surface roughness and has a plated film to be described in detail later, excellent sliding characteristics can be exhibited and superior wear resistance can be obtained even if the large diameter portion 21a of the piston rod 21 repeatedly slides against the seal material 35.

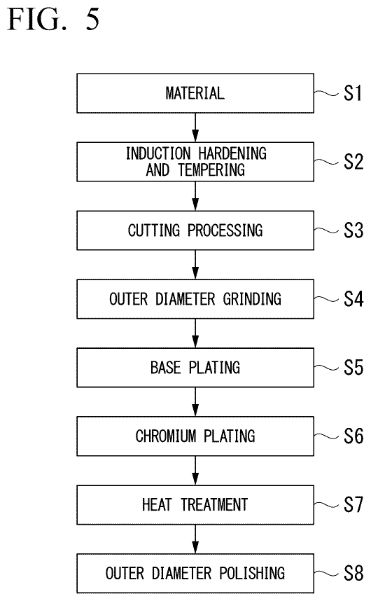

FIG. 5 is a flowchart showing an example of a manufacturing process for the piston rod 21.

As shown in step S1 of FIG. 5, a rod material such as a steel rod made of a steel material of a required type for forming the piston rod 21 is prepared.

The rod material is subjected to a heat treatment such as induction hardening and tempering in step S2 to apply a surface hardening treatment suitable for a piston rod.

Next, in step S3, cutting processing is performed to obtain an approximate shape shown in FIGS. 1 to 4, and in step S4, an outer diameter grinding processing is performed.

Next, the piston rod having the approximate shape shown in FIGS. 1 to 4 is subjected to a base plating treatment such as nickel plating in step S5, and then to a chromium plating treatment mainly composed of chromium formed using a trivalent chromium bath in step S6. Further, in step S5 in which the base plating treatment is performed, other base plating treatment may be performed instead of the nickel plating, or the base plating may be omitted by omitting step S5 of performing the plating treatment.

After the plating treatment in step S6, a heat treatment is performed in step S7. The heat treatment can be performed at a temperature of 250° C. to 400° C. for several hours. Further, after the plating treatment, since a baking treatment can also be performed for the purpose of removing hydrogen, the baking treatment and the heat treatment may be used in combination.

Next, in step S7, outer diameter polishing of the piston rod is performed, precision finishing is performed, and thereby a piston rod with a final surface shape can be obtained.

In the present embodiment, the plating treatment performed in step S6, the heat treatment performed in step S7, and the chromium-plated film, which is mainly composed of chromium formed using a trivalent chromium bath, formed on the piston rod are distinctive features.

The chromium-plated film applied in the present embodiment is mainly composed of chromium and contains, as other elements, one or more impurity elements selected from carbon (C) and oxygen (O).

For example, the chromium-plated film preferably contains 60 at % or more of chromium and 1 at % to 30 at % of carbon with a surface indentation hardness of 11.1 GPa or more.

However, the indentation hardness indicates a value obtained by instrumented indentation hardness measurement conducted using a nanoindentation method (ISO 14577). For example, an indentation load of 20 mN can be applied.

Of the above-described elements, the chromium-plated film may contain oxygen in an amount of about 2 at % to 6 at %. Further, in addition to the above-described elements, the chromium-plated film may contain either chlorine (Cl) or iron (Fe) as an impurity element in an amount of about 5 at % or less.

Also, the carbon content described above is more preferably about 8 at % to 25 at %, and the oxygen content is more preferably about 2 at % to 5 at %.

The chromium used in the trivalent chromium bath that forms the plated film is a main component, and is preferably included in as large an amount as possible. The carbon contained in the plated film is thought to originate from organic components constituting the plating bath as will be described below, if the carbon content is less than 8 at %, it is thought that there is a higher likelihood of brittle-mode tearing marks occurring during the outer diameter polishing. Based on an upper limit of a concentration of organic salts added to the plating bath, a maximum carbon content that can be contained in the plated film is considered to be 30 at %.

The oxygen content in the plated film is in a range of 2 at % to 6 at %.

If the oxygen content is less than 2 at %, there is a problem in that a likelihood of occurrence of brittle-mode tearing marks will increase, and if the oxygen content exceeds 6 at %, there is a problem in that a likelihood of occurrence of brittle-mode tearing marks will increase to the same extent as above.

In the plated film of the present embodiment, an elemental analysis can be performed using an electron probe micro analyzer (EPMA), and conditions such as, for example, an acceleration voltage of 10 kV and an irradiation current of 100 nA can be employed.

Further, in the present specification, when a numerical range is defined and an upper limit value and a lower limit value are indicated with “to,” the concept is to be understood as including the upper limit value and the lower limit value unless otherwise specified. Therefore, the above-described 1 at % to 30 at % means a range of 1 at % or more and 30 at % or less.

The above-described impurity elements other than chromium are presumed to originate from organic components included in the plating bath such as a carboxylate, a pH buffer, and a conductivity salt to be described below.

In the chromium-plated film according to the present embodiment, an impurity content in the plated film varies depending on plating treatment conditions, and it is considered that a current density, a bath temperature, and a pH condition contribute to the impurity content.

The reason why these serve as causes is presumably that incorporation of additives during chromium deposition is affected by a current density (reduction rate), a bath temperature (reduction rate), and pH (complex formation and reduction rate).

In the present embodiment, the plating bath used in the chromium plating treatment can use a plating bath containing components such as a trivalent chromium salt, a complexing agent as an additive, a pH buffer, and a conductivity salt.

As the trivalent chromium salt, chromium chloride, chromium sulfate, basic chromium sulfate, and the like can be used, and among these, it is preferable to use chromium chloride.

As the complexing agent, carboxylates such as glycine, formic acid, oxalic acid, acetic acid, and the like can be used, and among these, it is preferable to use glycine.

As the pH buffer, boric acid, citric acid, and the like can be used, and among these, it is preferable to use boric acid.

As the conductivity salt, ammonium chloride, ammonium sulfate, ammonium sulfonate, and the like can be used, and among these, it is preferable to use ammonium chloride.

When a strongly acidic trivalent plating bath is used, it is desirable to select a plating bath with a strong acidity weaker than pH 0.1, for example, a strong acidity within a range of pH 0.1 to pH 0.6, and more preferably a strong acidity within a range of pH 0.2 to pH 0.5.

If it is a strong acidity of pH 0.1 or lower, the plated film mainly composed of chromium formed using a trivalent chromium bath as intended in the present embodiment cannot be obtained, and if the pH exceeds 0.6, the plated film mainly composed of chromium as intended in the present embodiment cannot be obtained due to reasons such as poor gloss of the plated film and changes in incorporation of impurity elements during chromium deposition caused by variations in film formation rate.

When a weakly acidic trivalent chromium bath is used as the plating bath, Blue Chromium (trade name manufactured by Atotech) can be used as an example of a commercially available product. When Blue Chromium is used, a pH range of 5.2 to 5.8 can be selected as an example. The pH value is more preferably in a range of 5.4 to 5.6.

A higher current density during the plating treatment results in a faster film formation rate and leads to better productivity, but to achieve the above-described composition, a current density in a range of 45 to 100 A/dm² can be selected. The film formation rate increases under conditions of a high current density and high concentration of the trivalent chromium salt, but the incorporation of impurity elements when chromium is deposited changes due to variations in the film formation rate. It is desirable to set a suitable film formation rate to obtain the desired chromium content and the carbon content described above in the resulting plated film.

Further, a higher plating bath temperature is desirable, and a range of, for example, 55° C. to 80° C. can be selected.

As an agitation method for the plating bath, a gentle agitation method such as causing a plating solution to flow in the vicinity of a surface to be plated is desirable. As for an anode material, those having satisfactory insolubility such as Pt, Ti, Ir, and graphite can be used.

The chromium-plated film formed by the above-described plating treatment has an amorphous structure during film formation. It is preferable to subject the plated film having an amorphous structure to a heat treatment at a heating temperature of 250° C. to 400° C. to form a plated film with a degree of crystallinity of 5% or more.

A degree of crystallinity is a value calculated from a peak integrated intensity ratio of a measured value of X-ray diffraction measurement and the following expression (1).

$$Degree of crystallinity ( peak integrated intensity ratio ) = \{ ( Crystalline ) / ( Crystalline + Amorphous ) \} \times 100 \% \qquad Expression ( 1 )$$

Here, the integrated intensity ratio in expression (1) indicates a value determined in an X-ray diffraction (XRD) analysis under conditions of 2θ: 30° to 60°, a half width of crystalline: <3, and a half width of amorphous: ≥3.

The above-described heat treatment is performed to increase a degree of crystallinity of the plated film to 5% or more. A heat treatment time is preferably about 1.5 to 4.0 hours, for example, about 2 hours. A heat treatment at a temperature exceeding 400° C. is undesirable because it changes mechanical properties of the steel material constituting the piston rod 21.

The degree of crystallinity is more preferably in a range of 5% to 95%.

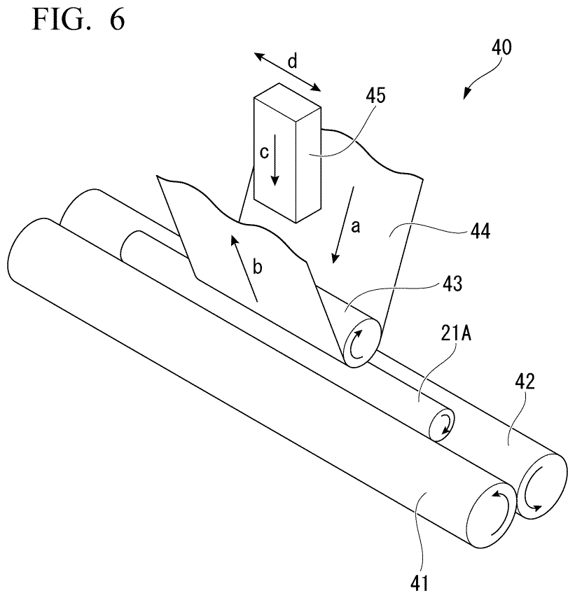

It is desirable that the plated film of the present embodiment do not easily generate abrasive marks due to a brittle mode when polishing processing is performed. For example, abrasive marks caused when polishing is performed using a film polishing device shown in FIG. 6 will be observed.

A film polishing device 40 shown in FIG. 6 includes drive rollers 41 and 42 disposed close to each other horizontally to be rotatable around their respective axes with portions of their circumferential surfaces in close proximity to each other, and is configured so that a rod material 21A for the piston rod to be processed can be placed on a boundary portion between these adjacent drive rollers 41 and 42.

When the rod material 21A is placed on the boundary portion between the drive rollers 41 and 42 that are disposed close to each other, the supported rod material 21A can be rotated about an axis thereof as the drive rollers 41 and 42 rotate.

A backup roller 43 that is rotatable around the circumference is disposed horizontally above the rod material 21A on the boundary portion between the drive rollers 41 and 42, and it is configured such that a polishing film 44 can be supplied to a bottom surface side of the backup roller 43 from a film supply device (not shown).

The polishing film 44 is a band-shaped film and can be supplied to the bottom surface side of the backup roller 43 from the film supply device (not shown) provided on one side of the backup roller 43 in a direction perpendicular to a central axis thereof as indicated by arrow a. Also, the film 44 can be moved to a film winding device (not shown) provided on the other side of the backup roller 43 in a direction perpendicular to the central axis and wound up as indicated by arrow b. The polishing film 44 can be wound onto the film supply device by a required length and continuously supplied to the bottom surface side of the backup roller 43.

The backup roller 43 is supported by a vertical movement mechanism (not shown) to be rotatable while maintaining a horizontal state, but is also supported by the vertical movement mechanism so that a vertical position thereof can be finely adjusted.

A pressing head 45 supported by a vertical and horizontal movement mechanism (not shown) is provided above the backup roller 43. The pressing head 45 can press the backup roller 43 downward with a predetermined pressing force while descending from a position slightly above the backup roller 43 as indicated by arrow c. Also, the pressing head 45 is also supported to be movable in the axial direction of the backup roller 43 as indicated by arrow d by the above-described vertical and horizontal movement mechanism, and the pressing head 45 is supported to be reciprocally movable in the axial direction of the backup roller 43 while maintaining a state of pressing the backup roller 43 downward with a predetermined force.

A polishing test of the piston rod is conducted using three film polishing devices shown in FIG. 6 with, for example, a #600 polishing film loaded in a first film polishing device, a #400 polishing film loaded in a second film polishing device, and a #2000 polishing film loaded in a third film polishing device.

Further, polishing conditions for these are equivalent to the polishing conditions applied to sample 2 shown in FIG. 28 of PCT International Publication No. WO 2021/193107. During polishing, a rotation speed of the drive rollers 41 and 42 was set to 1400 rpm, and a pressing force by the pressing head 45 was set to 0.15 to 0.3 MPa. The steel rod used for the test had a diameter of 22 mm and a length of 200 mm.

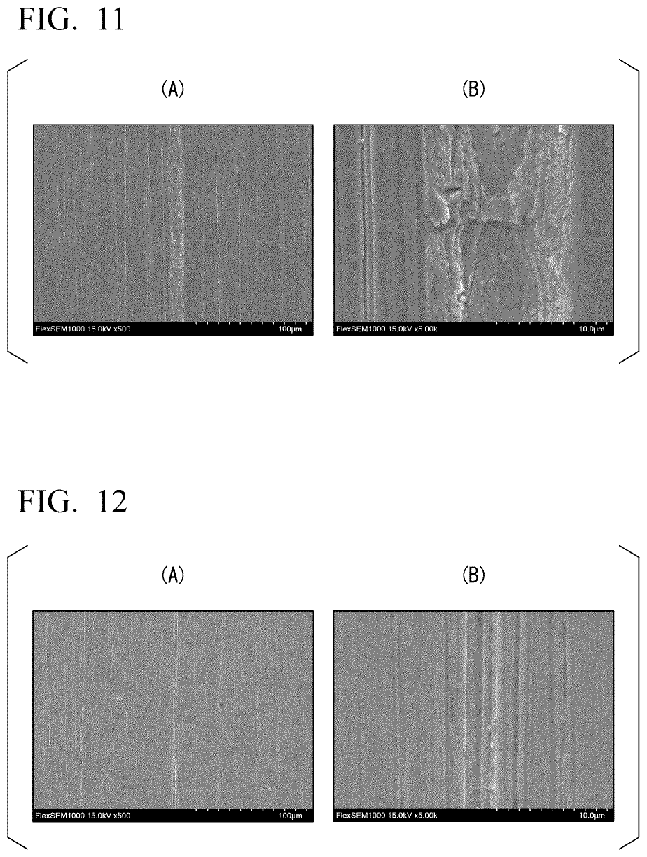

When the above-described polishing processing is performed, as an example, resulting samples will be those shown in examples and comparative examples to be described later such as, for example, either a sample with abrasive marks in brittle mode as shown in FIGS. 11(A) and 11(B) or a sample with abrasive marks in ductile mode as shown in FIGS. 12(A) and 12(B).

The abrasive marks shown in FIGS. 11(A) and 11(B) are from a sample having abrasive marks in brittle mode that exhibit tearing marks caused by brittle fracture as is clear from the enlarged image of FIG. 11(B).

The abrasive marks shown in FIGS. 12(A) and 12(B) are from a sample having abrasive marks in ductile mode that do not have tearing marks as is clear from the enlarged image of FIG. 12(B).

If the plated film that generates the abrasive marks shown in FIGS. 11(A) and 11(B) is used as the plated film of the piston rod 21 shown in FIGS. 1 to 4, abrasive marks in brittle mode that exhibit tearing marks are generated on the surface when the outer diameter polishing in step S8 shown in FIG. 5 is performed, and it will not be possible to achieve a desired surface roughness.

The film polishing device 40 shown in FIG. 6 is a device for finishing the outer circumferential surface of the piston rod, and is a device that performs polishing that is important for finishing the outer circumferential surface of the piston rod to a desired surface roughness. If the above-described abrasive marks in brittle mode are generated during the outer diameter polishing, it adversely affects a finishing accuracy of the outer circumferential surface of the piston rod, making it impossible to achieve excellent sliding characteristics, wear resistance, and corrosion resistance.

Therefore, for the sample in which the above-described polishing test was performed as the plated film provided on the piston rod 21 applied in the present embodiment, for example, abrasive marks on the surface are observed under a microscope at a magnification of 200 times. Then, it is preferable to use a plated film selected after measuring the number and a width of abrasive marks in the same field of view, determining the number of abrasive marks with a width of 8 μm or more, and evaluating quality of the plated film based on the number of abrasive marks generated.

Further, the reason why abrasive marks with a width of 8 μm or more were used as the evaluation criterion is that, when polishing tests were conducted on a plurality of samples in the examples to be described later, abrasive marks in brittle mode in which tearing marks were generated were mostly 8 μm or more in width.

From results of the examples to be described later, it is desirable to use a chromium-plated film which contains, in addition to chromium, one or more impurity elements selected from carbon and oxygen, containing 60 at % or more of chromium and 1 at % to 30 at % of carbon, and having an indentation hardness of 11.1 GPa or more on the outer surface and a degree of crystallinity of 5% or more after heat treatment.

The above-described chromium-plated film can be obtained by performing a plating treatment using a plating bath containing, for example, the above-described trivalent chromium salt, carboxylate, pH buffer, and conductivity salt under conditions of a pH of 0.1 to 0.6, a bath temperature of 55° C. to 80° C., and a cathode current density of 45 A/dm² to 100 A/dm².

The plated film formed on the outer circumferential surface of the piston rod 21 under the above-described conditions and heat-treated has a plating hardness of 11.1 GPa or more and a degree of crystallinity of 5% or more. If the above-described plated film has a plating hardness of 11.1 GPa or more and a degree of crystallinity of 5% or more, even if the outer diameter polishing is performed under the above-described conditions using the film polishing device 40 shown in FIG. 6, it is less likely to generate tearing marks (fracture marks due to the brittle mode).

Therefore, even if the above-described polishing processing is performed, the piston rod 21 without tearing marks can be obtained.

Incidentally, in the above-described embodiment, a plated member in which a chromium-plated film using a trivalent chromium bath is formed on the piston rod (sliding contact member) 21 has been described, but, in addition to this, the plated film may also be applied to sliding surfaces of various sliding contact members including automobile parts such as piston rings and brake pistons, as well as shafts of hydraulic equipment and gravure rolls of printing equipment.

### Examples

A plurality of steel rods (diameter 22 mm, length 200 mm) made of low-carbon steel were prepared as test materials, and a plating bath to which chromium chloride, glycine, boric acid, and ammonium chloride were added was used as a trivalent chromium plating bath. A plating treatment was performed under conditions of a bath temperature of 65 to 75° C., a current density of 45 to 100 A/dm², and a pH of 0.3 to 0.46, and a trivalent chromium-plated film of approximately 20 μm in thickness was formed on a surface of the test material.

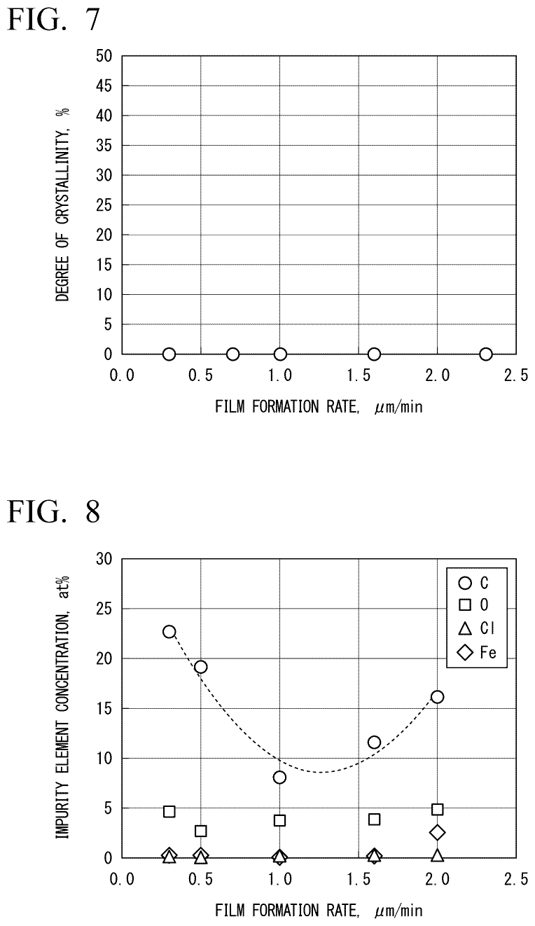

FIG. 7 shows results of determining a degree of crystallinity (%) of each plated film based on the above-described expression (1) when plated films were formed on test materials at five different film formation rates by adjusting the current density. In all the film formation rates, since only a halo pattern was observed in a range of 2θ: 30° to 60° in X-ray diffraction (XRD) analysis results, the plated films in their as-formed state were found to be amorphous films with a degree of crystallinity of 0.0%.

FIG. 8 shows component analysis results of the plated films formed at five different film formation rates. The component analysis was conducted by an electron probe microanalyzer under conditions of an acceleration voltage of 10 kV and an irradiation current of 100 nA.

As shown in FIG. 8, it was possible to ascertain that the chromium-plated films using the trivalent chromium bath at various film formation rates contained trace amounts of chlorine and iron as impurity elements in addition to carbon and oxygen.

Of these impurity elements, carbon, which had the highest content, was contained at about 7 at % to 23 at %, and oxygen, the second most abundant, was contained at about 3 at % to 5 at %. In addition, chlorine and iron are found to be contained in trace amounts near the detection limits.

From FIG. 8, it can be seen that the carbon content can be adjusted by adjusting the film formation rate of the plated film. Further, the film formation rate can be set to a condition exceeding 2.0 μm/min, and can also be adjusted by an amount of chromium chloride added to the chromium plating bath. Therefore, it can be recognized that the carbon content can be adjusted within a range of 5 at % to 30 at % by adjusting the plating conditions.

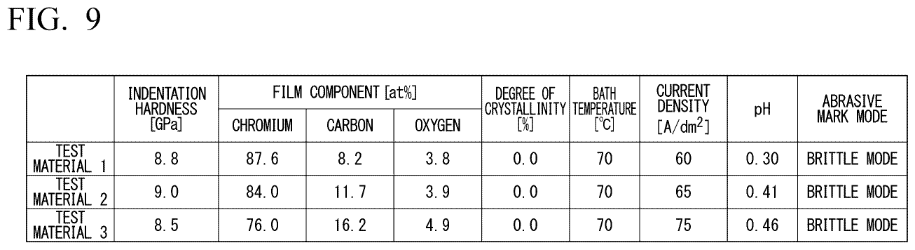

Three types of plated films were selected from the plurality of plated films, indentation hardnesses of the plated films were measured for these samples, the samples whose hardness was measured were subjected to a component analysis, and results of calculating a degree of crystallinity are shown in FIG. 9. However, the indentation hardness refers to a value obtained by instrumented indentation hardness measurement using a nanoindentation method (ISO 14577). An indentation load of 20 mN was used.

The plated films of the test materials 1 to 3 shown in FIG. 9 had an indentation hardness of 8.5 GPa to 9.0 GPa, a degree of crystallinity of 0% (amorphous), a chromium content of 76% to 88%, and a carbon content of 8% to 16%.

When the polishing test described below was conducted on the test materials 1 to 3 shown in FIG. 9, the abrasive marks were determined to be in the brittle mode, and thus “Brittle mode” was indicated in a column of “Abrasive mark mode” in FIG. 9. Also, a pH of a plating solution used for preparing the test material is as shown in FIG. 9.

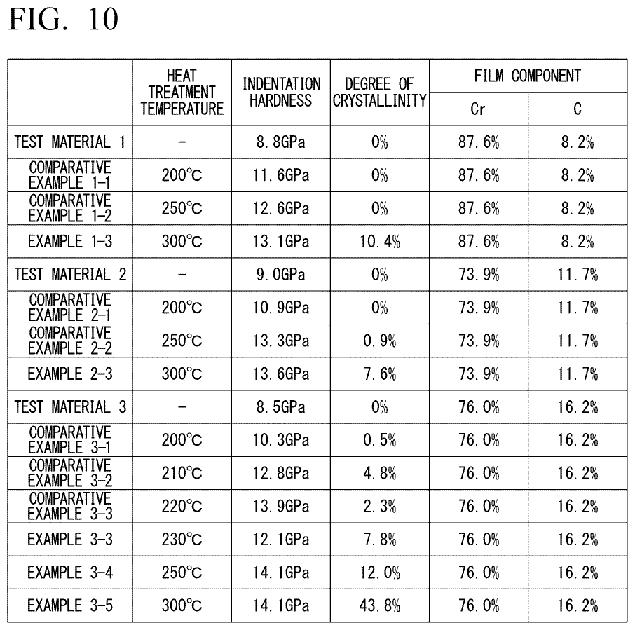

For samples of the test materials 1 to 3, an indentation hardness was measured, a degree of crystallinity was calculated, and a film composition was analyzed using the test materials after heat treatment at 200° C., 250° C., and 300° C. for two hours each, with the results shown in FIG. 10.

“Polishing test” A polishing test was conducted using four film polishing devices shown in FIG. 6, with a #600 polishing film loaded in a first film polishing device, a #400 polishing film loaded in a second film polishing device, and a #2000 polishing film loaded in a third film polishing device.

Further, this polishing condition is the same as that applied to Sample 2 shown in FIG. 28 of PCT International Publication No. WO 2021/193107. During polishing, a rotation speed of the drive rollers 41 and 42 was set to 1400 rpm, and a pressing force by the pressing head 45 was set to 0.15 MPa to 0.3 MPa.

Among the samples subjected to the polishing test, for the sample of comparative example 1-1 which was obtained by heat treating the test material 1 at 200° C. for two hours, an image of a surface of the piston rod captured at a magnification of 500 times using a scanning electron microscope is shown in FIG. 11(A), and an image captured at a magnification of 5000 times is shown in FIG. 11(B). Vertical streaks extending in a vertical direction can be observed in FIG. 11, and traces of the polishing that were made as the polishing film moved in a direction of these vertical streaks can be seen.

As shown in the enlarged view in FIG. 11(B), abrasive marks (tearing marks) that are thought to be tearing fractures caused by brittle fracture are formed in a movement direction of the polishing film. This abrasive mark can be expressed as an abrasive mark in brittle mode.

Also, for the sample of example 1-3 which was obtained by heat treating the test material 1 at 300° C. for two hours, an image of a surface of the piston rod captured at a magnification of 500 times using a scanning electron microscope is shown in FIG. 12(A), and an image captured at a magnification of 5000 times is shown in FIG. 12(B).

As shown in the enlarged view in FIG. 12(B), flow-shaped abrasive marks in the movement direction of the polishing film are generated due to shear deformation. This abrasive mark can be expressed as an abrasive mark in ductile mode.

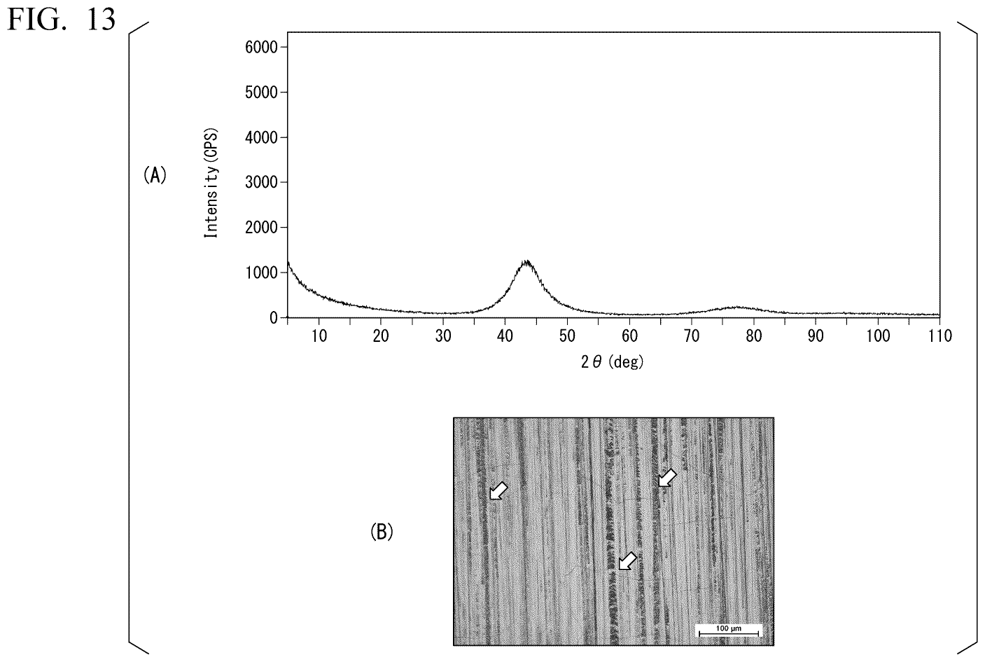

FIG. 13(A) shows X-ray diffraction analysis results for a sample (amorphous plated film) of the test material 3, and FIG. 13(B) is a surface image of the same sample at a magnification of 200 times showing abrasive marks. In the surface image shown in FIG. 13(B), three abrasive marks (accompanied by tearing fractures) with a width of 8 μm or more can be observed in the areas in front of the arrows.

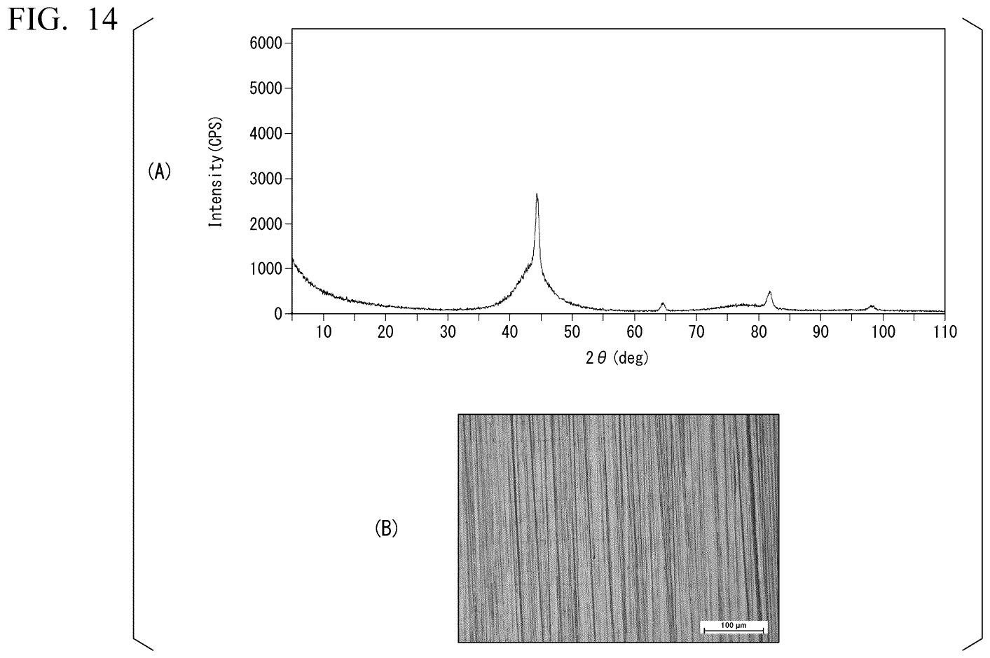

FIG. 14 is a diagram showing X-ray diffraction analysis results of example 3-4 in which the sample of test material 3 was subjected to a heat treatment (baking treatment) at 250° C. for two hours. From the X-ray diffraction analysis results shown in FIG. 14, it can be determined that the sample of example 3-5 in which the test material 3 was heat-treated at 250° C. is a sample having a high degree of crystallinity with a sharp peak.

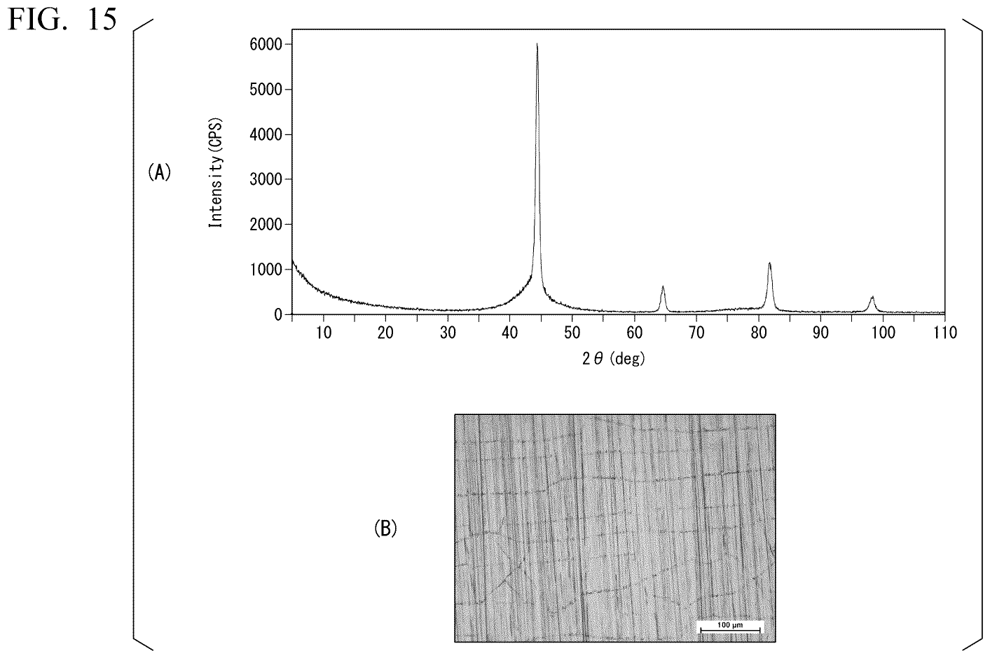

FIG. 15(A) shows X-ray diffraction analysis results for a sample in which the sample of test material 3 was subjected to a heat treatment (baking treatment) at 300° C. for two hours, and FIG. 15(B) is a surface image showing abrasive marks of the same sample.

From the X-ray diffraction analysis results shown in FIG. 13(A), it can be seen that the sample of test material 3 is a 100% amorphous sample (degree of crystallinity of 0.0%) exhibiting only a halo pattern. In contrast, from the X-ray diffraction analysis results shown in FIG. 15(A), it can be determined that the sample of example 3-5, in which the test material 3 was heat-treated at 300° C., is a crystalline sample having a sharp peak.

The amorphous plated film shown in FIG. 13(B) had three abrasive marks with a width of 8 μm or more, whereas the crystalline plated film shown in FIG. 15(B) did not have any abrasive marks with a width of 8 μm or more.

According to the above-described expression (1), Degree of crystallinity (peak integrated intensity ratio)={(Crystalline)/(Crystalline+Amorphous)}×100%, the integrated intensity ratio of expression (1) is determined in FIG. 13(A) under conditions of 2θ: 30° to 60°, a half width of crystalline: <3, and a half width of amorphous: ≥3.

From the X-ray diffraction analysis results shown in FIG. 13(A), a degree of crystallinity calculated on the basis of expression (1) is 0%.

From the X-ray diffraction analysis results shown in FIG. 14(A), a degree of crystallinity calculated on the basis of expression (1) is 13.2%, and from the X-ray diffraction analysis results shown in FIG. 15(A), a degree of crystallinity calculated on the basis of expression (1) is 12%.

Therefore, it can be seen that a crystalline plated film with a degree of crystallinity of 5% or more, for example, a plated film with a degree of crystallinity of 7% to 44% as shown in FIG. 10, is less likely to generate problematic abrasive marks in brittle mode.

Inclusive of the samples shown in FIG. 10, a plurality of other piston rods prepared under the same polishing conditions as these samples were observed at three locations on each sample using a metallurgical microscope to determine the number and widths of friction marks present within a 200× magnification field of view.

As a result, a plurality of abrasive marks with a width of 8 μm or more could be observed in both the samples that had not been heat-treated and the samples that had been heat-treated at 200° C., and it was possible to ascertain that tearing fractures were generated in the abrasive marks with a width of 8 μm or more. Also, in the samples of the examples shown in FIG. 10, abrasive marks with tearing marks were not observed.

From the above results, when the above-described polishing test was conducted on the plated films, it was determined that measuring the number of abrasive marks with a width of 8 μm or more serves as an indicator of whether the plated film exhibits a brittle mode or a ductile mode in the above-described polishing test.

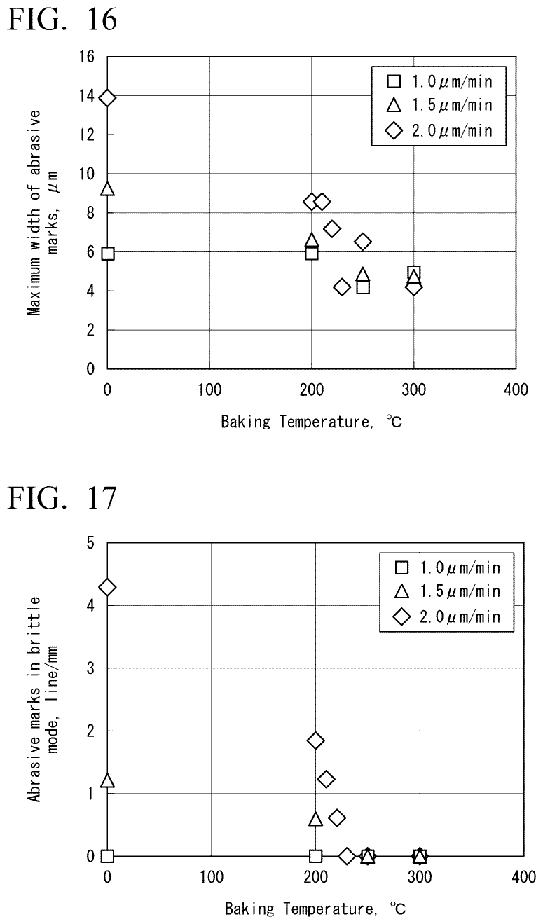

FIG. 16 is a graph showing a relationship between a heat treatment temperature (expressed as a baking temperature in the figure) and a maximum width of abrasive marks generated in the above-described polishing test, in the plated films formed at each deposition rate (film formation rate).

It can be seen that, in the samples in which the heat treatment temperature was set to 200° C., a plurality of abrasive marks with a width of 8 μm or more were generated, but when the heat treatment temperature was set to 250° C. or 300° C., no abrasive marks with a width of 8 μm or more were generated.

FIG. 17 is a graph showing a relationship between a heat treatment temperature (baking temperature) and the number of abrasive marks having a width of 8 μm or more generated in the above-described polishing test, in the plated films formed at each deposition rate (film formation rate).

It can be seen that, in the samples in which the heat treatment temperature was set to 200° C., a plurality of abrasive marks with a width of 8 μm or more were generated, but when the heat treatment temperature was set to 250° C. or 300° C., no abrasive marks with a width of 8 μm or more were generated.

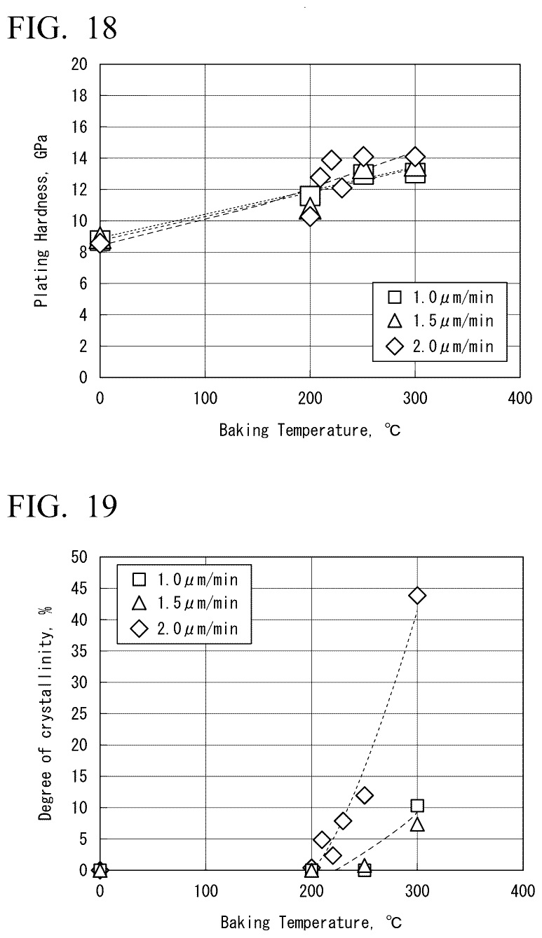

FIG. 18 is a graph showing a relationship between a heat treatment temperature (baking temperature) and a plating hardness in the plated films formed at each deposition rate (film formation rate).

In the samples that were not heat-treated and the samples that were heat-treated at a temperature of 200° C., there were samples with a hardness of less than 11.1 GPa, but it can be seen that when the heat treatment temperature was set to 250° C. or 300° C., the hardness of the plated film exceeded 11.1 GPa.

FIG. 19 is a graph showing a relationship between a heat treatment temperature (baking temperature) and a degree of crystallinity in the plated films formed at each film formation rate.

It can be seen that when the heat treatment temperature exceeds 200° C., crystallization progresses, and when the heat treatment temperature exceeds 250° C., a degree of crystallinity increases, resulting in a plated film with a degree of crystallinity of 5% or more.

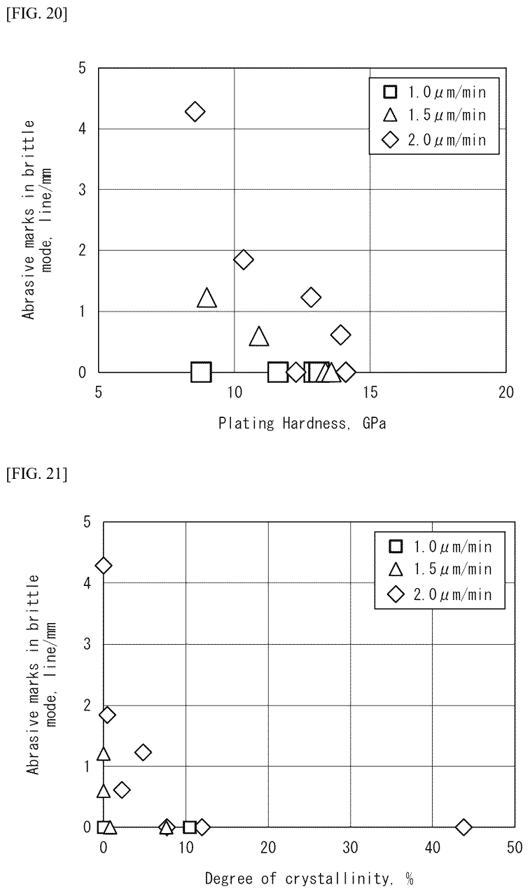

FIG. 20 shows results of measuring a hardness of the plated film (GPa) and the number of abrasive marks (marks/mm) with a width of 8 μm or more in the plated films formed at each deposition rate (film formation rate).

FIG. 21 shows results of measuring a degree of crystallinity (%) of the plated film and the number of abrasive marks (marks/mm) with a width of 8 μm or more for the example samples and the comparative example sample.

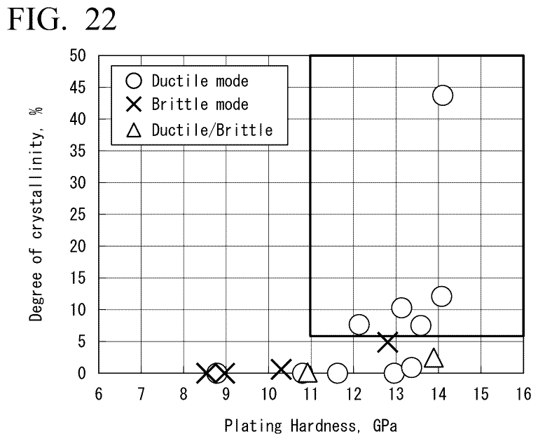

FIG. 22 shows a correlation between a hardness of the plated film and a degree of crystallinity of the plated film based on the results shown in FIGS. 20 and 21.

As shown in FIG. 21, it can be seen that there is a significant difference in the number of generated abrasive marks in brittle mode with a degree of crystallinity of 5% as the boundary. When a degree of crystallinity is less than 1%, differences in the number of generated abrasive marks in brittle mode are observed depending on the test materials, but when a degree of crystallinity is 5% or more, a frequency of generation of the abrasive marks in brittle mode is low in all the samples, which is desirable.

As shown in FIG. 22, it can be seen that samples having a surface indentation hardness of the plated film higher than a hardness of the plated film of approximately 11.1 GPa have a degree of crystallinity of 5% or more.

When the surface indentation hardness is 10.3 GPa or more, it is preferable as the number of generated abrasive marks with a width of 8 μm or more can be suppressed, and when the surface indentation hardness is 10.9 GPa or more, it is more desirable as a frequency of generation of them is further reduced. In the samples with the heat treatment temperature of 250° C. or higher, all the samples had values exceeding 11 GPa (11.1 GPa or higher), which was suitable.

From these results, it is considered that the film properties are derived from organic components such as a carboxylate, a pH buffer, and a conductivity salt in the plating bath. Furthermore, it is considered that an amount of organic components incorporated into the film also changes according to conditions of a pH, a bath temperature, and a current density during plating. Further, it was found that, by subjecting the plated film to heat treatment to achieve a degree of crystallinity of 5% or more, it is possible to produce a plated film that does not generate tearing marks even when a finishing treatment is performed by polishing.

### INDUSTRIAL APPLICABILITY

According to the above-described aspect of the present invention, it is possible to provide a plated member having a chromium-plated film which is a plated film mainly composed of chromium formed using a trivalent chromium bath that poses no environmental problems compared to hexavalent chromium and is less susceptible to occurrence of tearing fractures during polishing. It is also possible to provide a manufacturing method for manufacturing the plated member. Therefore, industrial applicability is high.

### REFERENCE SIGNS LIST

1 Shock absorber (cylinder device)
2 Inner cylinder (cylinder device)
3 Outer cylinder
15 Oil seal
21 Piston rod (sliding contact member)
25 Piston
A Sliding range

1. A plated member comprising, on an outer surface, a plated film mainly composed of chromium formed using a trivalent chromium bath containing at least chromium, carbon, and oxygen, wherein
the plated film contains 60 at % or more of chromium and 1 at % to 30 at % of carbon and has an indentation hardness of 11.1 GPa or more on the outer surface, and
a degree of crystallinity calculated from a peak integrated intensity ratio of a measured value of X-ray diffraction measurement and the following expression (1) is 5% or more,
$$Degree of crystallinity ( peak integrated intensity ratio ) = \{ ( Crystalline ) / ( Crystalline + Amorphous ) \} \times 100 \% \qquad Expression ( 1 )$$
Here, the indentation hardness indicates a value obtained by instrumented indentation hardness measurement using a nanoindentation method (ISO 14577), and the integrated intensity ratio in expression (1) indicates a value determined in an X-ray diffraction (XRD) analysis under conditions of 2θ: 30° to 60°, a half width of crystalline: <3, and a half width of amorphous: ≥3.

2. The plated member according to claim 1, being a sliding contact member which is in sliding contact with a sliding component.

3. The plated member according to claim 1, wherein an oxygen concentration of the plated film is 2 at % to 6 at %.

4. A manufacturing method of a plated member which is a plated member having, on an outer surface, a plated film which is mainly composed of chromium formed using a trivalent chromium bath containing at least chromium, carbon, and oxygen, contains 60 at % or more of chromium and 1 at % to 30 at % of carbon and has an indentation hardness of 11.1 GPa or more on the outer surface, and has a degree of crystallinity calculated from a peak integrated intensity ratio of a measured value of X-ray diffraction measurement and the following expression (1) being 5% or more,
the manufacturing method of a plated member comprising a plating process which forms a plated film made of a hard layer mainly composed of chromium on a surface of the plated member, and includes:
a first step of forming an amorphous plated film; and
a second step of heating and crystallizing the amorphous plated film formed in the first step, to make the indentation hardness of the outer surface of the amorphous plated film be 11.1 GPa or more,
$$Degree of crystallinity ( peak integrated intensity ratio ) = \{ ( Crystalline ) / ( Crystalline + Amorphous ) \} \times 100 \% \qquad Expression ( 1 )$$
Here, the indentation hardness indicates a value obtained by instrumented indentation hardness measurement using a nanoindentation method (ISO 14577), and the integrated intensity ratio in expression (1) indicates a value determined in an X-ray diffraction (XRD) analysis under conditions of 2θ: 30° to 60°, a half width of crystalline: <3, and a half width of amorphous: ≥3.

5. The manufacturing method of a plated member according to claim 4, wherein the plating process forms the plated film in a plating bath containing a trivalent chromium salt, a carboxylate, a pH buffer, and a conductivity salt at a bath temperature of 55° C. to 80° C. under conditions of a cathode current density of 45 A/dm² to 100 A/dm².

6. The manufacturing method of a plated member according to claim 4, wherein the plated member is a sliding contact member which is in sliding contact with a sliding component.

7. The manufacturing method of a plated member according to claim 4, wherein an oxygen concentration of the plated film is set to 2 at % to 6 at %.

8. The manufacturing method of a plated member according to claim 4, wherein a heating temperature performed in the second step is set to 250° C. to 400° C.
